(19) United States
(12) Patent Application Publication
(10) Pub. No.: US 2009/0317253 A1
(43) Pub. Date: Dec. 24, 2009

(54) Cylinder for varying the pitch angle of the blades of a horizontal axis windmill, and method of manufacture of the same

(76) Inventors: Yasuhiro Takata, Hakusan-shi (JP); Takashi Sakai, Hakusan-shi (JP); Masahiro Kaneko, Hakusan-shi (JP); Yasushi Nishimoto, Akashi-shi (JP); Nobuyuki Tanaka, Akashi-shi (JP); Shinjiro Nishikawa, Akashi-shi (JP)

Correspondence Address: JORDAN AND HAMBURG LLP, 122 EAST 42ND STREET, SUITE 4000, NEW YORK, NY, 10168, US

(21) Appl. No.: 12/387,248

(22) Filed: Apr. 30, 2009

(30) Foreign Application Priority Data
Jun. 18, 2008 (JP) 2008-158814

(51) Int. Cl. F03D 1/00; B23P 17/00

(52) U.S. Cl. 416/134 R; 29/889

(57) ABSTRACT

A cylindrical body arranged between a shaft body and a blade of a horizontal axis wind turbine is constituted of a cylindrical barrel portion, a first flange portion fixed to a first end of the barrel portion so that the blade is connected thereto, and a second flange portion fixed to a second end of the barrel portion and connected to the shaft body. The barrel portion is constituted of a cylindrically formed rubber stock and a plurality of filamentary bodies embedded in the rubber stock and arranged in a state inclined by a prescribed angle with respect to a direction parallel to an axial direction. When tensile force F develops in the barrel portion due to centrifugal force resulting from rotation of the blade, both opening ends of the barrel portion twistedly rotate due to actions of the filamentary bodies. Thus, it follows that the pitch angle of the blade connected to the first flange portion automatically varies with a wind speed.

### BACKGROUND OF THE INVENTION

1. Field of the Invention

The present invention relates to a cylindrical body for a horizontal axis wind turbine and a method of manufacturing the same, and more particularly, it relates to a cylindrical body for a horizontal axis wind turbine arranged between a shaft body and a blade of the horizontal axis wind turbine and a method of manufacturing the same.

2. Description of the Background Art

In a horizontal axis wind turbine aiming at power generation, it is preferable to change the pitch angle of each blade at a low speed in starting and the pitch angle of the blade at a rated wind speed after the starting.

Therefore, a horizontal axis wind turbine automatically changing this pitch angle of the blade in response to the wind speed is proposed (refer to Japanese Patent Laying-Open No. 2004-60646).

In this horizontal axis wind turbine, a mounting portion of each blade is supported by a holder to be slidable in the radial direction of a rotor shaft, and a spring hauling the blade to the central direction of the rotor shaft is provided. Further, a spiral guide groove and a guide pin guiding the blade to rotate the same around a blade axis when the blade moves outward in the radial direction of the rotor shaft due to centrifugal force resulting from rotation are provided.

Thus, the pitch angle of the blade automatically changes in response to the rotational speed of the blade.

In the aforementioned conventional horizontal axis wind turbine, the guide groove and the guide pin serving as variable structures for the pitch angle of the blade are exposed, and hence rust prevention is required. Even if rusting can be prevented, it cannot be said that there is no possibility that foreign matter or the like penetrates into the guide groove to inhibit movement of the guide pin.

The present invention has been proposed in order to solve the aforementioned problems, and aims at providing a cylindrical body for a horizontal axis wind turbine having no possibility of rusting and penetration of foreign matter and a method of manufacturing the same.

### SUMMARY OF THE INVENTION

In order to attain the aforementioned object, a cylindrical body for a horizontal axis wind turbine according to a first aspect of the present invention is a cylindrical body for a horizontal axis wind turbine arranged between a shaft body and a blade of the horizontal axis wind turbine, comprising a cylindrical barrel portion having flexibility, a first connecting portion fixed to a first end of the barrel portion so that the blade is connected thereto and a second connecting portion fixed to a second end of the barrel portion and connected to the shaft body, while the barrel portion is so formed that the first end twistedly rotates around an axial direction thereof with respect to the second end when tensile force acts in the axial direction and returns to the state before the rotation when the tensile force disappears.

According to this structure, the pitch angle of the blade changes when centrifugal force of the blade results from rotation of the shaft body.

The cylindrical body for a horizontal axis wind turbine according to a second aspect of the present invention is characterized in that the barrel portion includes a cylindrically formed rubber stock and a plurality of filamentary bodies embedded in the rubber stock and arranged in a state inclined by a prescribed angle with respect to a direction parallel to the axial direction at prescribed intervals in a peripheral direction in the structure of the invention according to the first aspect.

According to this structure, the filamentary bodies are deformed to approach the direction parallel to the axial direction when tensile force develops in the axial direction.

The cylindrical body for a horizontal axis wind turbine according to a third aspect of the present invention is characterized in that the barrel portion consists of a plurality of cylinders overlapped with each other and having concentric sections while each of the cylinders includes a cylindrically formed rubber stock and a plurality of filamentary bodies embedded in the rubber stock and arranged in a state inclined by a prescribed angle with respect to a direction parallel to the axial direction at prescribed intervals in a peripheral direction in the structure of the invention according to the first aspect.

According to this structure, the respective ones of the plurality of cylinders in the barrel portion are twisted.

The cylindrical body for a horizontal axis wind turbine according to a fourth aspect of the present invention is characterized in that the filamentary bodies include nylon cords in the structure of the invention according to the second aspect or the third aspect.

According to this structure, elongation of the filamentary bodies in the axial direction is suppressed.

The cylindrical body for a horizontal axis wind turbine according to a fifth aspect of the present invention is characterized in that at least a part of the barrel portion is folded in a perpendicular direction inward to constitute a first folded portion on the first end of the barrel portion, the barrel portion is connected to the first connecting portion by a first fastening member through the first folded portion, at least a part of the barrel portion is folded in the perpendicular direction outward to constitute a second folded portion on the second end of the barrel portion, and the barrel portion is connected to the second connecting portion by a second fastening member through the second folded portion in the structure of the invention according to any of the first aspect to the fourth aspect.

According to this structure, the barrel portion is connected to the first connecting portion and the second connecting portion by the first fastening member and the second fastening member through the first folded portion and the second folded portion.

A method of manufacturing a cylindrical body for a horizontal axis wind turbine according to a sixth aspect of the present invention is a method of manufacturing a cylindrical body for a horizontal axis wind turbine, having a cylindrical barrel portion arranged between a shaft body and a blade of the horizontal axis wind turbine, comprising the steps of forming a base sheet by embedding a plurality of filamentary bodies in a sheetlike elastic body in parallel with each other in a longitudinal direction and at identical intervals in a width direction, taking out a rectangular sheet body having one side in the longitudinal direction along a direction inclined by a prescribed angle with respect to the width direction from the base sheet, and forming the barrel portion by cylindrically bending the taken out sheet body so that the side forms one of opening end portions.

According to this structure, the barrel portion in which the arrangement of the filamentary bodies is regulated can be easily formed.

A method of manufacturing a cylindrical body for a horizontal axis wind turbine according to a seventh aspect of the present invention is a method of manufacturing a cylindrical body for a horizontal axis wind turbine, having a cylindrical barrel portion arranged between a shaft body and a blade of the horizontal axis wind turbine, comprising the steps of forming a base sheet by embedding a plurality of filamentary bodies in a sheetlike elastic body in parallel with each other in a longitudinal direction and at identical intervals in a width direction, taking out a rectangular sheet body having a longitudinal direction defined by a direction inclined by a prescribed angle with respect to the width direction from the base sheet, forming a plurality of notches in the elastic body in parallel with each other at regular intervals along the filamentary bodies in a first range and a second range inward from respective edges of a first long side and a second long side of the taken out sheet body, cylindrically bending the sheet body provided with the notches so that the first long side and the second long side form respective ones of opening end portions, and forming the barrel portion by folding the first range of the cylindrically bent sheet body in a perpendicular direction inward thereby forming a first folded portion while folding the second range in the perpendicular direction outward thereby forming a second folded portion.

According to this structure, the barrel portion, in which arrangement of the filamentary bodies is regulated, having the first folded portion and the second folded portion is formed from the base sheet.

A method of manufacturing a cylindrical body for a horizontal axis wind turbine according to an eighth aspect of the present invention is a method of manufacturing a cylindrical body for a horizontal axis wind turbine, having a cylindrical barrel portion arranged between a shaft body and a blade of the horizontal axis wind turbine, comprising the steps of forming a base sheet by embedding a plurality of filamentary bodies in a sheetlike elastic body in parallel with each other in a longitudinal direction and at identical intervals in a width direction, taking out substantially identical rectangular first and second sheet bodies having longitudinal directions defined by directions inclined by the same prescribed angle with respect to the width direction from the base sheet, forming a plurality of notches in the elastic body in parallel with each other at regular intervals along the filamentary bodies in first ranges and second ranges inward from respective edges of first long sides and second long sides of the respective ones of the taken out first and second sheet bodies, overlapping the first and second sheet bodies provided with the notches with each other and integrally cylindrically bending the same so that the first long sides and the second long sides of the respective ones form respective ones of opening end portions, and forming the barrel portion by folding the first ranges of the respective ones of the cylindrically bent first and second sheet bodies in a perpendicular direction inward in an overlapped state thereby forming first folded portions while folding the second ranges of the respective ones in the perpendicular direction outward in an overlapped state thereby forming second folded portions.

According to this structure, the barrel portion consisting of two layers, in which arrangement of the filamentary bodies is regulated, having the first folded portions and the second folded portions is formed from the base sheet.

A method of manufacturing a cylindrical body for a horizontal axis wind turbine according to a ninth aspect of the present invention is a method of manufacturing a cylindrical body for a horizontal axis wind turbine, having a cylindrical barrel portion arranged between a shaft body and a blade of the horizontal axis wind turbine, comprising the steps of forming a base sheet by embedding a plurality of filamentary bodies in a sheetlike elastic body in parallel with each other in a longitudinal direction and at identical intervals in a width direction, taking out substantially identical rectangular first and second sheet bodies having longitudinal directions defined by directions inclined by the same prescribed angle with respect to the width direction from the base sheet, taking out at least one rectangular third sheet body having a longitudinal direction defined by a direction inclined by an angle identical to the prescribed angle with respect to the width direction and being short only in a short-side direction in comparison with the first sheet body from the base sheet, overlapping the taken out third sheet body between the taken out first and second sheet bodies to be held therebetween and forming a plurality of notches in the elastic body in parallel with each other at regular intervals along the filamentary bodies in first ranges and second ranges, inward from respective edges of first long sides and second long sides of the respective ones of the first sheet body and the second sheet body, with which the third sheet body is not in contact, integrally cylindrically bending the overlapped first and second sheet bodies through the third sheet body so that the first long sides and the second long sides of the respective ones of the overlapped first and second sheet bodies form respective ones of opening end portions, and forming the barrel portion by folding the first ranges of the respective ones of the cylindrically bent first and second sheet bodies in a perpendicular direction inward thereby forming first folded portions while folding the second ranges of the respective ones in the perpendicular direction outward thereby forming second folded portions.

According to this structure, the barrel portion of at least three layers, in which arrangement of the filamentary bodies is regulated, having the first folded portions and the second folded portions is formed from the base sheet.

In the cylindrical body for a horizontal axis wind turbine according to the first aspect of the present invention, as hereinabove described, the pitch angle of the blade changes when centrifugal force develops in the blade following rotation, whereby the pitch angle in starting and after the starting can be automatically set to proper levels. Further, the barrel portion itself rotates so that both end portions are twisted, whereby there is no possibility of rusting and penetration of foreign matter.

In the cylindrical body for a horizontal axis wind turbine according to the second aspect of the present invention, the filamentary bodies are deformed to approach the direction parallel to the axial direction when tensile force develops in the axial direction in addition to the effects of the invention according to the first aspect, whereby the degree of twisting of the barrel portion can be easily controlled through the arrangement of the filamentary bodies.

In the cylindrical body for a horizontal axis wind turbine according to the third aspect of the present invention, the respective ones of the plurality of cylinders in the barrel portion are twisted in addition to the effects of the invention according to the first aspect, whereby twisting of the barrel portion is stabilized. Further, twisting force of the barrel portion can be easily controlled.

In the cylindrical body for a horizontal axis wind turbine according to the fourth aspect of the present invention, elongation of the filamentary bodies in the axial direction is suppressed in addition to the effects of the invention according to the second aspect or the third aspect, whereby rotation of the barrel portion is further stabilized.

In the cylindrical body for a horizontal axis wind turbine according to the fifth aspect of the present invention, the barrel portion is connected to the first connecting portion and the second connecting portion by the first fastening member and the second fastening member through the first folded portion and the second folded portion in addition to the effects of the invention according to any of the first aspect to the fourth aspect, whereby these can be reliably and easily fixed.

In the method of manufacturing a cylindrical body for a horizontal axis wind turbine according to the sixth aspect of the present invention, the barrel portion in which arrangement of the filamentary bodies is regulated can be easily formed, whereby stable functions of the cylindrical body are exhibited. When a large base sheet is formed, further, a plurality of cylindrical bodies can also be easily formed.

In the method of manufacturing a cylindrical body for a horizontal axis wind turbine according to the seventh aspect of the present invention, the barrel portion, in which arrangement of the filamentary bodies is regulated, having the first folded portion and the second folded portion is formed from the base sheet, whereby the cylindrical body integrated with connecting portions can be easily manufactured.

In the method of manufacturing a cylindrical body for a horizontal axis wind turbine according to the eighth aspect of the present invention, the barrel portion consisting of two layers, in which arrangement of the filamentary bodies is regulated, having the first folded portions and the second folded portions are formed from the base sheet, whereby a cylindrical body integrated with connecting portions with a sidewall relatively thick as compared with that formed by a single sheet body can be easily manufactured.

In the method of manufacturing a cylindrical body for a horizontal axis wind turbine according to the ninth aspect of the present invention, the barrel portion of at least three layers, in which arrangement of the filamentary bodies is regulated, having the first folded portions and the second folded portions is formed from the base sheet, whereby a cylindrical body integrated with connecting portions with a considerably thick sidewall can be easily manufactured while the degree of deformation of the cylindrical body resulting from torque can be easily controlled.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view schematically showing the shape of a horizontal axis wind turbine employing a cylindrical body according to a first embodiment of the present invention.

FIG. 2 is an enlarged exploded perspective view of a portion “X” shown in FIG. 1.

FIG. 3 is an enlarged sectional view taken along a line III-III shown in FIG. 2, showing a state where respective components are assembled.

FIG. 4 is an enlarged exploded perspective view for showing the components constituting the cylindrical body shown in FIG. 2.

FIG. 5 is a plan view schematically showing the shape of a base sheet serving as a base for manufacturing a barrel portion shown in FIG. 4.

FIG. 6 is an enlarged sectional view taken along a line VI-VI shown in FIG. 5.

FIG. 7 is a plan view in a state taking out a portion “Y” from the base sheet shown in FIG. 5.

FIG. 8 is a sectional view of a cylindrical body according to a second embodiment of the present invention, corresponding to FIG. 3 of the first embodiment.

FIG. 9 is an enlarged sectional view taken along a line IX-IX shown in FIG. 8.

FIG. 10 is an enlarged sectional view taken along a line X-X shown in FIG. 8.

FIG. 11 is a diagram showing a method of manufacturing the cylindrical body shown in FIG. 8.

FIG. 12 is a sectional view of a cylindrical body according to a third embodiment of the present invention, corresponding to FIG. 8 of the second embodiment.

FIG. 13 is an enlarged view of a portion “A” shown in FIG. 12.

FIG. 14 is a diagram showing a first half step of a method of manufacturing the cylindrical body shown in FIG. 12.

FIG. 15 is a sectional view showing a first latter half step subsequent to the first half step of FIG. 14.

FIG. 16 is a sectional view showing a second latter half step subsequent to the first latter half step of FIG. 15.

### DESCRIPTION OF THE PREFERRED EMBODIMENTS

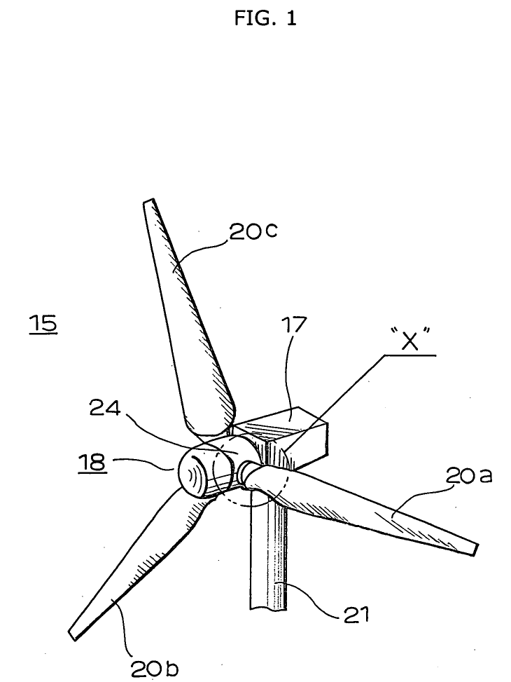

FIG. 1 is a schematic perspective view showing the external shape of a horizontal axis wind turbine provided with a cylindrical body for a horizontal axis wind turbine according to a first embodiment of the present invention.

Referring to the figure, a horizontal axis wind turbine 15 is constituted of a generator body 17 supported by a post 21 and provided with a generator stored therein, a shaft body 18 arranged in front of the generator body 17 and coupled to the generator of the generator body 17 through a rotating shaft and three blades 20a to 20c connected to a sidewall 24 of the shaft body 18 to extend outward from the shaft body 18. When the blades 20a to 20c rotate by a wind, the rotation is transmitted to the generator body 17 through the shaft body 18, so that power is generated in response to the wind power.

According to this embodiment, the blades 20a to 20c are so connected to the shaft body 18 that the pitch angles thereof change in response to the wind speed.

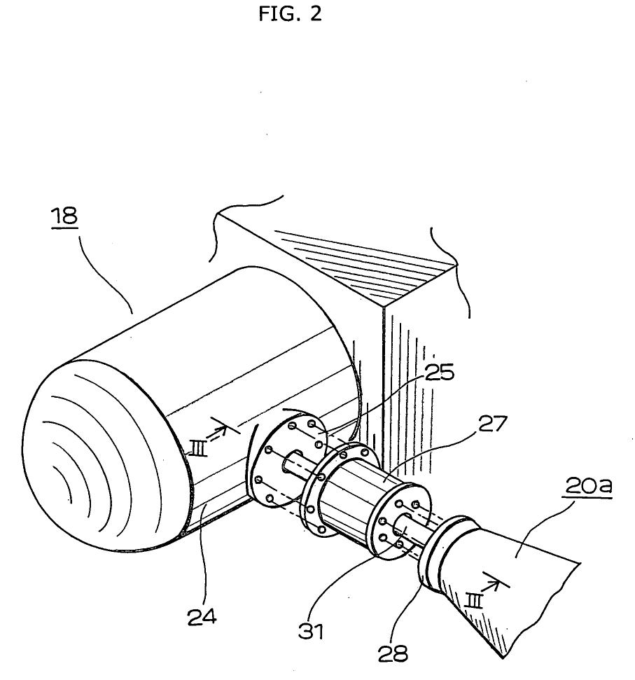

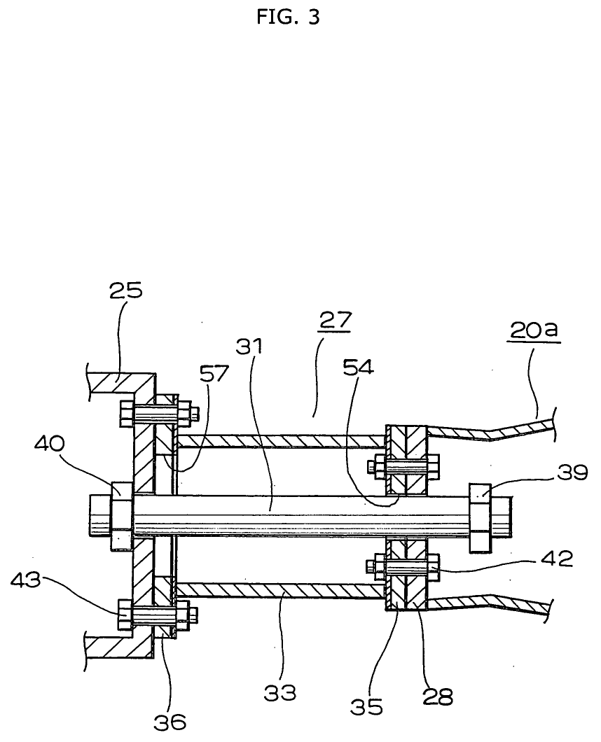

FIG. 2 is an enlarged exploded perspective view of a portion “X” shown in FIG. 1, and FIG. 3 is an enlarged sectional view taken along the line III-III shown in FIG. 2, illustrating a state of connecting respective components with each other.

Referring to these figures, a cylindrical body 27 is constituted of a cylindrical barrel portion 33 having flexibility, a first flange portion 35 fixed to a first end of the barrel portion 33 closer to the blade 20a and a second flange portion 36 fixed to a second end of the barrel portion 33 closer to the shaft body 18. The first flange portion 35 of the cylindrical body 27 is connected to a fixing portion 28 of the blade 20a through a bolt/nut assembly 42. On the other hand, the second flange portion 36 of the cylindrical body 27 is connected to a connecting portion 25 formed on the sidewall 24 of the shaft body 18 through a bolt/nut assembly 43.

A support shaft 31 is mounted on the central portions of the cylindrical body 27, the blade 20a and the connecting portion 25 to pass through these components in the state where the same are connected with each other. The support shaft 31 is employed for supporting the blade 20a and limiting displacement and preventing inclination of the blade 20a with respect to the connecting portion 25. Therefore, a nut 39 is mounted on a position slightly separating from the fixing portion 28 on the side of the support shaft 31 closer to the blade 20a, while a nut 40 is mounted on an end portion of the support shaft 31 closer to the connecting portion 25 in a state in contact with the connecting portion 25.

A procedure of assembling these components is described later.

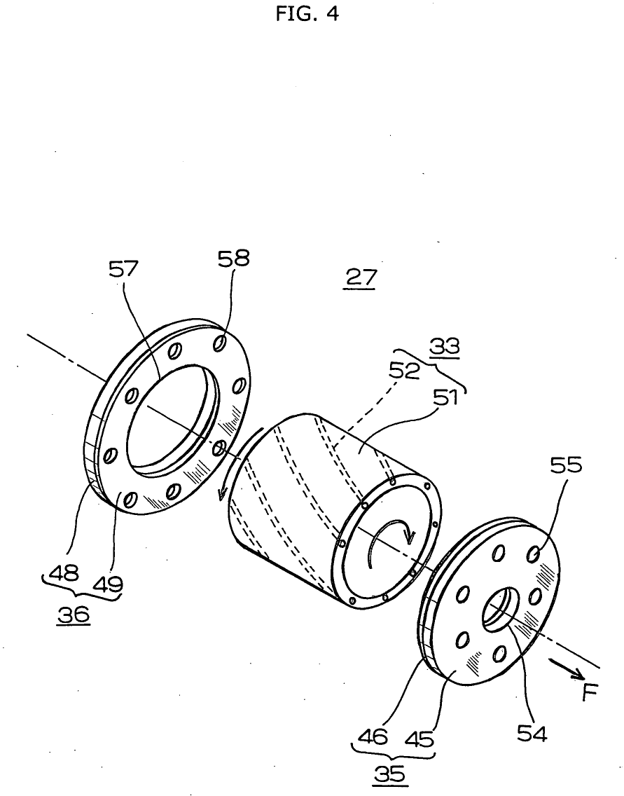

FIG. 4 is an exploded perspective view for showing the components of the cylindrical body 27 shown in FIG. 3.

Referring to the figure, the cylindrical body 27 is constituted of the barrel portion 33, the first flange portion (first connecting portion) 35 and the second flange portion (second connecting portion) 36, as hereinabove described. The barrel portion 33 is mainly constituted of a rubber stock 51 which is an elastic body, and a plurality of filamentary bodies 52 consisting of nylon cords (unidirectional fibers) or the like are embedded therein in a state inclined by a prescribed angle with respect to the axial direction of the rubber stock 51 at constant intervals from each other. Due to functions of these filamentary bodies 52, the filamentary bodies 52 are deformed to approach the axial direction when tensile force F develops in the axial direction of the rubber stock 51. Consequently, it follows that the barrel portion 33 rotates in a direction shown by arrow. In other words, it follows that the rubber stock 51 so rotates that a first end twistedly rotates around the axial direction with respect to a second end when the tensile force acts in the axial direction thereof. On the other hand, when the acting tensile force disappears, it follows that the rubber stock 51 returns to the state before the rotation due to the elastic function thereof.

In the first flange portion 35, a rubber sheet 46 is bonded to one surface of a discoidal metal plate 45 of iron, and integrated with the rubber stock 51 of the barrel portion 33 by vulcanization bonding. A shaft hole 54 capable of receiving the support shaft 31 shown in FIG. 3 is formed in the center of the metal plate 45, and a plurality of bolt openings 55 for mounting the bolt/nut assembly 42 shown in FIG. 3 are formed in the periphery thereof.

On the other hand, the second flange portion 36 is mainly constituted of a discoidal metal plate 48 of iron, while a rubber sheet 49 is bonded to one surface of the metal plate 48 and integrated with the rubber stock 51 of the barrel portion 33 by vulcanization bonding. A working opening 57 sufficiently large in diameter with respect to the support shaft 31 of FIG. 3 is formed in the central portion of the second flange portion 36, and a plurality of bolt openings 58 for mounting the bolt/nut assembly 43 shown in FIG. 3 are formed in the periphery thereof.

Referring again to FIG. 3, a procedure of mounting the blade 20a and the cylindrical body 27 on the connecting portion 25 is described.

First, a first end of the support shaft 31 is inserted into the blade 20a through the shaft opening 54 of the cylindrical body 27. The nut 39 is meshed with the forward end side of the support shaft 31 in this state, and thereafter fixed to the support shaft 31 by spot welding. At this time, the nut 39 is fixed to be on a position separating from the inner surface side of the fixing portion 28 so as to keep a prescribed distance after assembling.

Then, the first flange portion 35 of the cylindrical body 27 and the fixing portion 28 of the blade 20a are connected with each other by the bolt/nut assembly 42. The large working opening 57 is formed in the second flange portion 36 of the cylindrical body 27, whereby the bolt/nut assembly 42 can be fixed from the side of the working opening 57 at this time.

Then, a second end of the support shaft 31 is inserted into the connecting portion 25, and the connecting portion 25 and the second flange portion 36 are connected with each other by the bolt/nut assembly 43 in this state. After the connection between the cylindrical body 27 and the connecting portion 25 is completed, the nut 40 is meshed with the second end of the support shaft 31 from the inside of the connecting portion 25, and fixed to the support shaft 31 and the connecting portion 25 by spot welding or the like.

Thus, the blade 20a is connected to the connecting portion 25 through the cylindrical body 27, while it follows that the weight of the blade 20a is supported by the connecting portion 25 through the support shaft 31. The surface of the barrel portion 33 of the cylindrical body 27 is entirely covered with the rubber stock 51, whereby there is no possibility of rusting and penetration of foreign matter problematic in the structure of the conventional example.

Functions of the cylindrical body according to the first embodiment of the present invention are now described with reference to FIGS. 2 to 4.

When the blade 20a starts rotating around the shaft body 18 by a wind, it follows that centrifugal force following the rotational speed develops in the axial direction of the cylindrical body 27. The fixing portion 28 of the blade 20a is connected to be slidable with respect to the support shaft 31 as shown in FIG. 3, whereby it follows that the centrifugal force developing in the blade 20a is transmitted to the cylindrical body 27 as the tensile force F developing in the axial direction thereof. When the tensile force F develops, the barrel portion 33 is going to twistedly rotate in the direction of arrow, as shown in FIG. 4. Both ends of the barrel portion 33 are fixed to the first flange portion 35 and the second flange portion 36. Further, the second flange portion 36 is fixed to the connecting portion 25 through the bolt/nut assembly 43 to be not rotatable in the axial direction, as shown in FIG. 3. Therefore, it follows that the twisting of the barrel portion 33 is transmitted to the fixing portion 28 of the blade 20a as rotation of the first flange portion 35. Consequently, it follows that the pitch angle of the blade 20a with respect to the shaft body 18 changes. In other words, it follows that the pitch angle of the blade 20a varies with the magnitude of the centrifugal force of the blade 20a, i.e., the magnitude of the wind speed.

On the other hand, when the wind speed lowers and the centrifugal force developing in the blade 20a decreases, it follows that the tensile force F applied to the cylindrical body 27 also decreases. Then, the rotation of the barrel portion 33 by twisting is relaxed, and changes to approach the state before the rotation. Consequently, it follows that the pitch angle of the blade 20a also changes to approach the state in starting.

The length of the barrel portion 33 in the longitudinal direction thereof slightly increases when the twisting results from the tensile force F. As a result, it follows that the positions of the first flange portion 35 and the fixing portion 28 shown in FIG. 3 move rightward in the figure. Therefore, the nut 39 is mounted on the position separating from the fixing portion 28, so that the nut 39 mounted on the support shaft 31 does not come into contact with the fixing portion 28 to inhibit movement thereof.

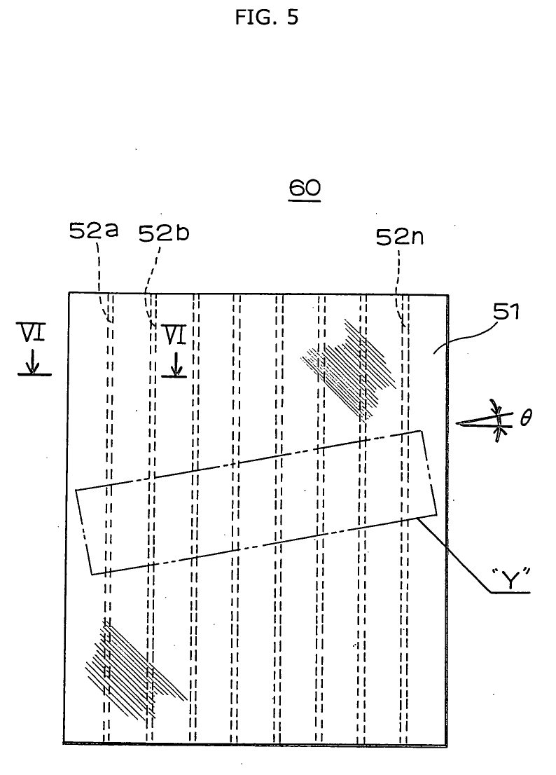

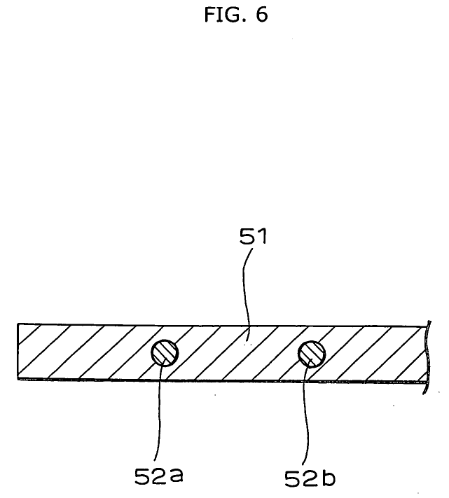

FIG. 5 is a plan view showing the external shape of a base sheet serving as a base for manufacturing the barrel portion of the cylindrical body shown in FIG. 4, and FIG. 6 is an enlarged sectional view taken along the line VI-VI shown in FIG. 5.

Referring to these figures, a base sheet 60 is constituted of a plurality of n filamentary bodies 52a and 52b to 52n arranged in parallel with each other in the longitudinal direction and at identical intervals in the width direction and the sheetlike rubber stock 51 for embedding these filamentary bodies 52. More specifically, the filamentary bodies 52 are nylon cords employed as tire cords, and the rubber stock 51 is made of natural rubber, EPDM, SBR or mixed rubber of these. Thus, it follows that the base sheet 60 in which the regularly arranged filamentary bodies 52 are embedded in the rubber stock 51 is precisely manufactured.

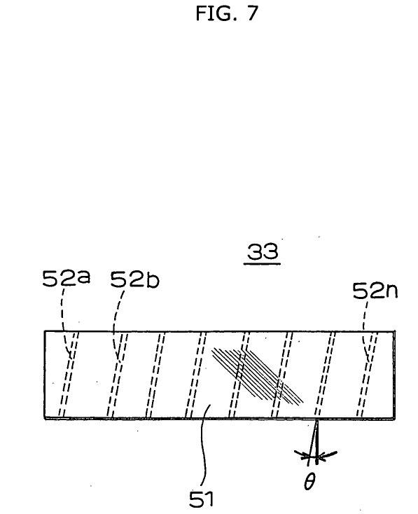

FIG. 7 is a plan view in a case of cutting and taking out a portion “Y” from the base sheet 60 shown in FIG. 5.

Referring to the figure, a sheet taken out from the base sheet 60 of FIG. 5 corresponds to a state developing the barrel portion 33 of the cylindrical body 27 shown in FIG. 4. Referring to FIG. 5, this is taken out from the base sheet 60 as a sheet body having one side (long side) in the longitudinal direction along a direction inclined by θ with respect to the width direction thereof. Therefore, the filamentary bodies 52 are embedded in the rubber stock 51 in a state inclined by the angle θ with respect to the short-side direction as the barrel portion 33, as shown in FIG. 7. The barrel portion 33 shown in FIG. 4 can be manufactured by cylindrically bending the barrel portion 33 obtained in this manner so that the long side forms an opening end portion. Thus, the filamentary bodies 52 are regularly embedded in the rubber stock 51 in the barrel portion 33, whereby the twisting resulting from the tensile force is stably exhibited, to improve reliability in the mounting state.

While only the portion “Y” is regarded as the cut object in FIG. 5, that of the same angle of inclination or that of a different angle of inclination can be easily precisely taken out in a similar manner. Further, a plurality of cylindrical bodies can also be easily formed at once by forming the base sheet 60 in a larger size.

When cylindrical bodies used for the respective blades of a single horizontal axis wind turbine are acquired from the same base sheet in this manner, dispersion of functions in the respective cylindrical bodies is suppressed, and reliability of the overall horizontal axis wind turbine is improved.

When θ is increased in FIG. 7, the degree of twisting as the cylindrical body is reduced with respect to the same tensile force. Thus, a proper cylindrical body can be easily obtained by deciding θ in response to necessity for the magnitude of change of the pitch angle.

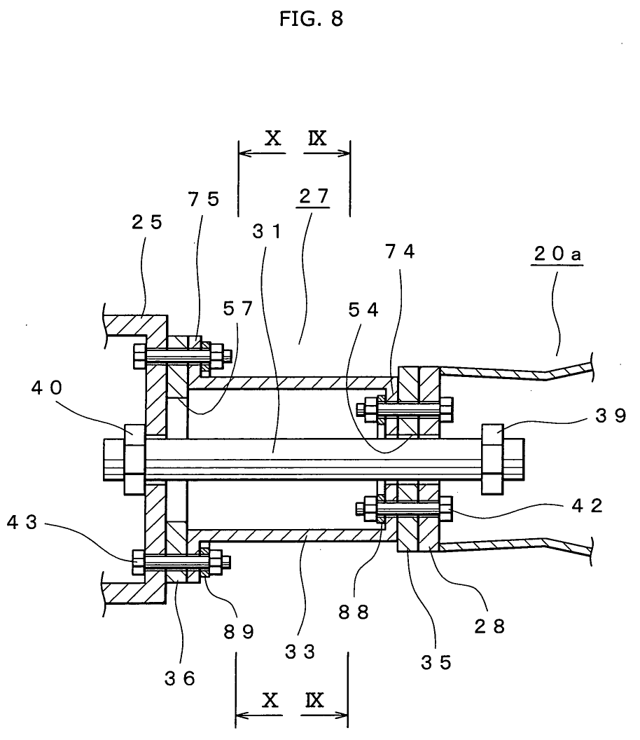

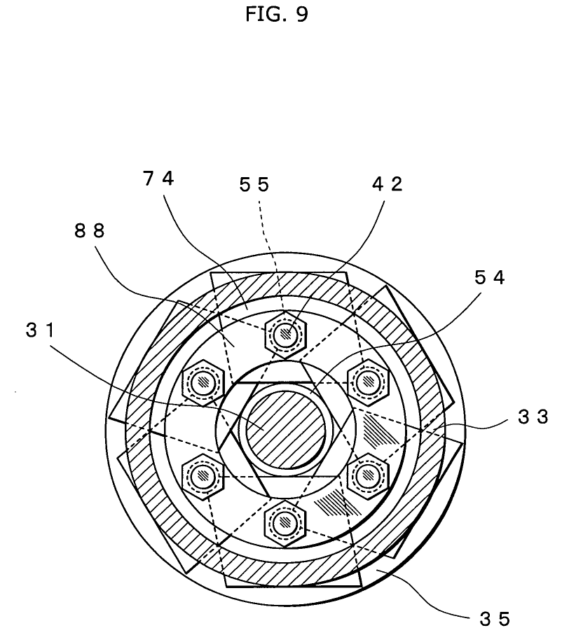

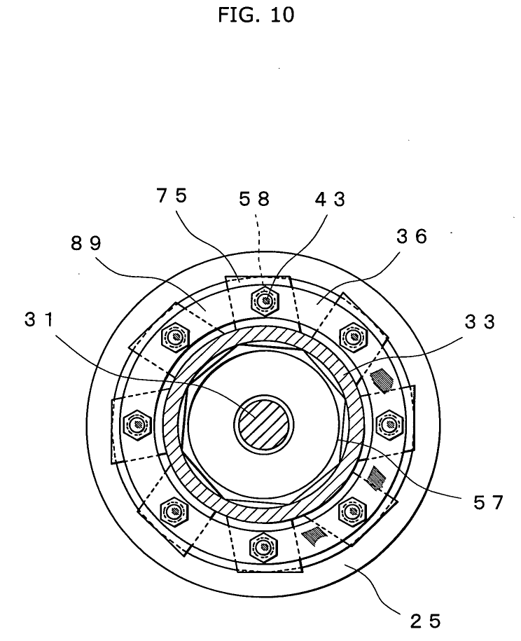

FIG. 8 is a sectional view of a cylindrical body according to a second embodiment of the present invention and corresponds to FIG. 3 of the first embodiment, FIG. 9 is an enlarged sectional view taken along the line IX-IX shown in FIG. 8, and FIG. 10 is an enlarged sectional view taken along the line X-X shown in FIG. 8.

The second embodiment is basically identical to the first embodiment, and hence the same is described with reference to different points.

Referring to these figures, methods of connecting a barrel portion 33 and respective ones of a first flange portion 35 and a second flange portion 36 are remarkably different in this embodiment. In other words, the barrel portion 33 and the first flange portion 35 are fixed to each other with a bolt/nut assembly 42 which is a first fastening member through a ring-shaped presser plate 88, while the barrel portion 33 and the second flange portion 36 are fixed to each other with a bolt/nut assembly 43 which is a second fastening member through a ring-shaped presser plate 89. The details are now described.

A plurality of notches are formed in a first end of the barrel portion 33 closer to a blade 20a, and the barrel portion 33 includes first folded portions 74 formed by folding the first end provided with the notches in a perpendicular direction inward. Each of the first folded portions 74 is provided with a bolt opening 55, and connected by the bolt/nut assembly 42 along with the first flange portion 35 and a fixing portion 28 of the blade 20a through a ring-shaped presser plate 88 arranged on a side of the first folded portion 74 closer to a shaft body. Further, a plurality of notches are formed in a second end of the barrel portion 33 closer to the shaft body, and the barrel portion 33 includes second folded portions 75 formed by folding the second end provided with these notches in the perpendicular direction outward. Each of the second folded portions 75 is provided with a bolt opening 58 and connected by a bolt/nut assembly 43 along with the second flange portion 36 and a connecting portion 25 through a ring-shaped presser plate 89 arranged on a side of the second folded portion 75 closer to the blade 20a, similarly to the first folded portion 74. Pressing force resulting from fastening of the bolt/nut assemblies 42 and 43 is uniformly transmitted to the first folded portions 74 and the second folded portions 75 by the presser plates 88 and 89.

As hereinabove described, the barrel portion 33 is connected to the first flange portion 35 which is a first connecting portion and the second flange portion 36 which is a second connecting portion through the presser plates 88 and 89 by the bolt/nut assembly 42 which is the first fastening member and the bolt/nut assembly 43 which is the second fastening member through the first folded portions 74 and the second folded portions 75, whereby these can be reliably and easily fixed.

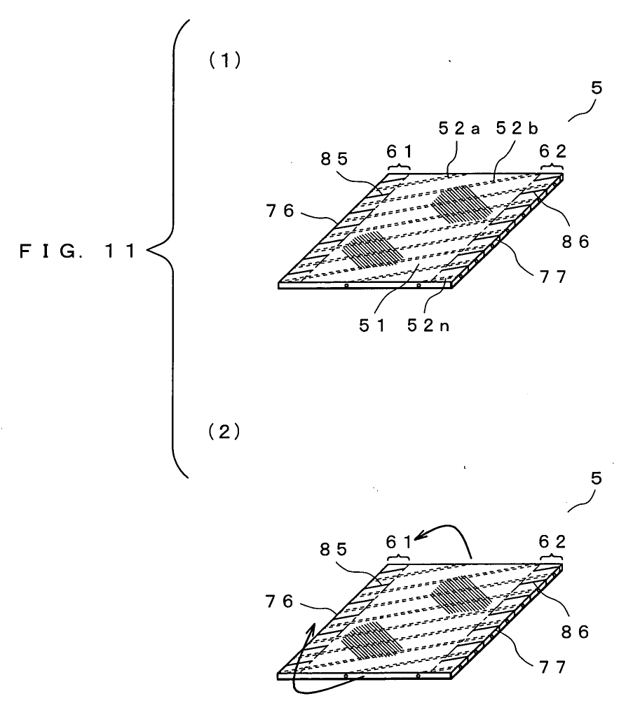

FIG. 11 is a diagram showing a method of manufacturing the cylindrical body shown in FIG. 8.

Referring to the figure, a sheet body 5 taken out by cutting the portion “Y” from the base sheet 60 of FIG. 5 corresponds to a state developing the barrel portion 33 of the cylindrical body 27 shown in FIG. 8.

First, a plurality of notches 85 are formed in an elastic body 51 in parallel with each other along the filamentary bodies 52a and 52b to 52n at regular intervals in a first range 61 inward from an edge of a first long side 76 of the sheet body 5 in the longitudinal direction, as shown at (1). Also in a second range 62 inward from an edge of a second long side 77 of the sheet body 5 in the longitudinal direction, a plurality of notches 86 are formed in the elastic body 51 similarly to the first range 61.

Then, the sheet body 5 is cylindrically bent so that the first long side 76 and the second long side 77 of the sheet body 5 provided with the plurality of notches 85 and 86 form respective ones of opening end portions of the barrel portion, as shown at (2).

Then, the first range 61 of the cylindrically bent sheet body 5 is folded in a perpendicular direction toward the inner side of the opening to form the first folded portions 74 shown in FIG. 9, and the bolt openings 55 for the first fastening member are further formed in the respective ones of the first folded portions 74. In the second range 62, the second range 62 is bent in the perpendicular direction toward the outer side of the opening to form the second folded portions 75 shown in FIG. 10, and the bolt openings 58 for the second fastening member are formed in the respective ones of the second folded portions 75. Thus, the barrel portion 33 shown in FIG. 8 is formed.

When the barrel portion 33 is formed by such a method, the barrel portion 33, in which arrangement of the filamentary bodies 52a and 52b to 52n is regulated, having the first folded portions 74 and the second folded portions 75 is formed from the base sheet 60. Therefore, the cylindrical body integrated with connecting portions in the barrel portion 33 can be easily manufactured.

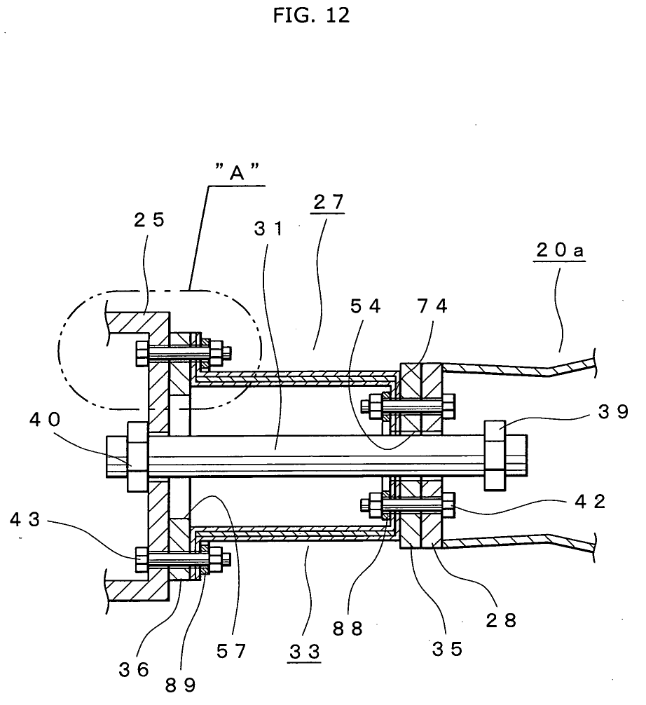

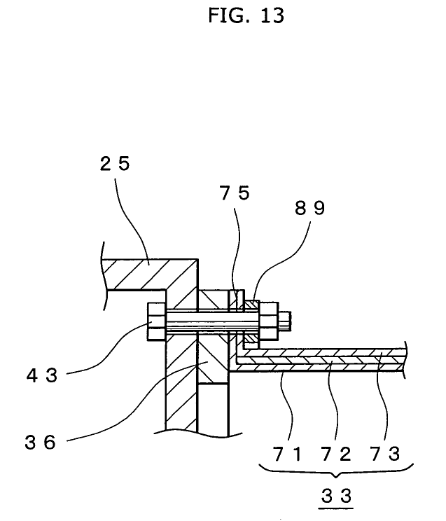

FIG. 12 is a sectional view of a cylindrical body according to a third embodiment of the present invention and corresponds to FIG. 8 of the second embodiment, while FIG. 13 is an enlarged view of a portion “A” shown in FIG. 12.

The third embodiment is basically identical to the second embodiment, and hence the same is described with reference to different points.

Referring to these figures, the structure of a barrel portion 33 is remarkably different in this embodiment. In other words, the barrel portion 33 is constituted of a first cylinder 71, a second cylinder 72 and a third cylinder 73 overlapped with each other and having concentric sections. The material for each cylinder is identical to the material for the barrel portion described with reference to FIG. 4.

Different points in methods of connecting the barrel portion 33 with respective ones of a first flange portion 35 and a second flange portion 36 are now described.

According to this embodiment, the first cylinder 71, the second cylinder 72 and the third cylinder 73 are so formed as to be layered in sectional states. First folded portions 74 are formed on first ends of the respective cylinders closer to a blade 20a by the first cylinder 71 located on the innermost position and the third cylinder 73 located on the outermost position among these cylinders, similarly to those shown in FIG. 8. Further, second folded portions 75 are formed on second ends of the respective cylinders. The shapes of the respective folded portions and the methods of connecting the respective folded portions and the respective ones of the first flange portion 35 and the second flange portion 36 are similar to those shown in FIG. 8. While the second cylinder 72 is not connected with the first flange portion 35 and the second flange portion 36, the arrangement position thereof is held since the same is covered with the first cylinder 71 and the third cylinder 73.

In such a cylindrical body 27, the respective ones of the first cylinder 71, the second cylinder 72 and the third cylinder 73 are twisted due to the aforementioned tensile force F, whereby twisting of the barrel portion 33 is stabilized. Further, the barrel portion is formed by the plurality of cylinders, whereby twisting force can be easily controlled.

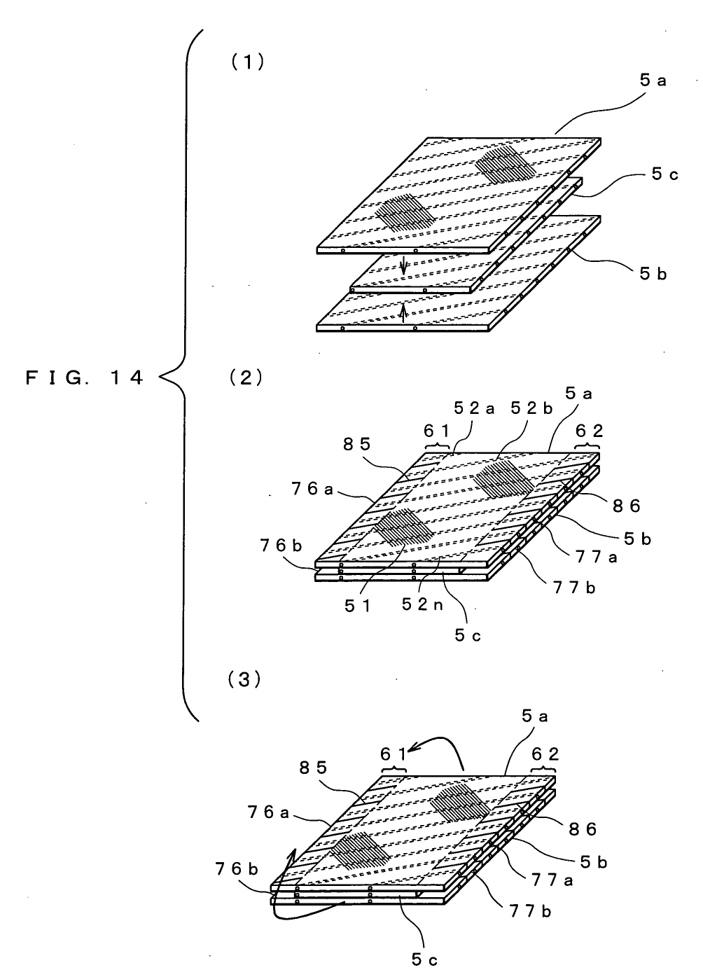

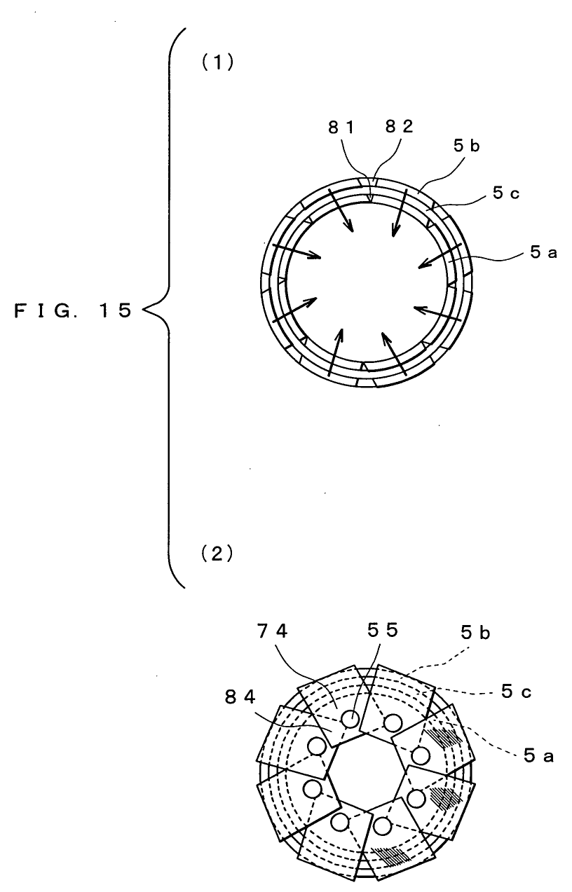

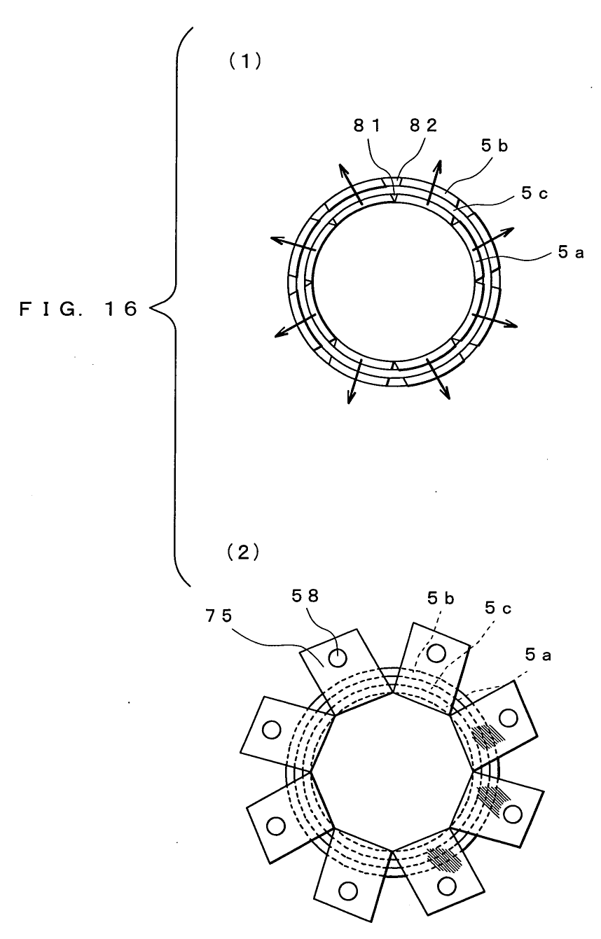

FIG. 14 is a diagram showing a first half step of a method of manufacturing the cylindrical body shown in FIG. 12, FIG. 15 is a sectional view showing a first latter half step subsequent to the first half step of FIG. 14, and FIG. 16 is a sectional view showing a second latter half step subsequent to the first latter half step of FIG. 15.

First, substantially identical rectangular first and second sheet bodies 5a and 5b corresponding to the portion “Y” are taken out from the base sheet 60 of FIG. 5, as shown at (1) in FIG. 14. Further, directions inclined by the same prescribed angle with respect to the width direction are regarded as the longitudinal directions in the first sheet body 5a and the base sheet 60. A rectangular third sheet body 5c short only in a short-side direction in comparison with the first sheet body 5a is taken out. The third sheet body 5c is overlapped between the first sheet body 5a and the second sheet body 5b to be held therebetween.

Then, in first ranges 61 inward from the respective edges of first long sides 76a and 76b of the respective ones of the first sheet body 5a and the second sheet body 5b, with which the third sheet body 5c is not in contact, a plurality of notches 85 are formed in respective elastic bodies 51 in parallel with each other along filamentary bodies 52a and 52b to 52n at regular intervals, as shown at (2) in FIG. 14. Also in second ranges 62 inward from the respective edges in second long sides 77a and 77b of the respective ones of the first sheet body 5a and the second sheet body 5b, with which the third sheet body 5c is not in contact, a plurality of notches 86 are formed in the elastic bodies 51 similarly to the first ranges 61.

Then, the sheet bodies are integrally cylindrically bent so that the first long sides 76a and 76b and the second long sides 77a and 77b of the respective ones of the first sheet body 5a and the second sheet body 5b overlapped through the third sheet body 5c form respective ones of opening end portions in the barrel portion, as shown at (3) in FIG. 14. Then, the opening end portion closer to the first long sides 76a and 76b has a sectional shape shown at (1) in FIG. 15, while the opening end portion closer to the second long sides 77a and 77b has a sectional shape shown at (1) in FIG. 16. At this time, it follows that clearances 81 and 82 are formed in the notch portions due to the difference between the circumferences of these in the first sheet body 5a and the second sheet body 5b.

Then, the first ranges 61 of the respective ones of the first sheet body 5a and the second sheet body 5b among these cylindrically folded sheet bodies are folded in the perpendicular direction toward the inner side of the opening to form first folded portions 74, as shown at (2) in FIG. 15. Further, bolt openings 55 for a first fastening member are formed in the respective ones of the formed first folded portions 74. At this time, overlapped portions 84 are formed between the respective ones of the first folded portions 74.

Then, the second ranges 62 of the respective ones of the first sheet body 5a and the second sheet body 5b among these cylindrically bent sheet bodies are folded in the perpendicular direction toward the outer side of the opening to form second folded portions 75, as shown at (2) in FIG. 16. Further, bolt openings 58 for a second fastening member are formed in the respective ones of the formed second folded portions 75.

When the barrel portion 33 is formed by such a method, the three-layer barrel portion 33, in which arrangement of the filamentary bodies 52a and 52b to 52n is regulated, having the first folded portions 74 and the second folded portions 75 is formed from the base sheet 60. Therefore, a cylindrical body integrated with connecting portions in the barrel portion 33 with a considerably thick sidewall can be easily manufactured, while the degree of deformation of the cylindrical body resulting from torque can be easily controlled.

While FIGS. 14 to 16 show the method of forming the barrel portion by the first sheet body, the second sheet body and the third sheet body, the barrel portion can be similarly formed also when a plurality of third sheet bodies are provided. Alternatively, the barrel portion can be similarly formed also when no third sheet is provided.

While the folded portions are formed in the order of the first latter half step and the second latter half step subsequent thereto in FIGS. 14 to 16, the order of the first latter half step and the second latter half step may be reversed.

While both ends of the barrel portion are integrated with the flange portion by vulcanization bonding in the aforementioned first embodiment, peripheral edges of two discs constituting the connecting portions may be surrounded by the inner surfaces of both end portions of the barrel portion and the overall peripheries of the outer surfaces thereof may be fastened with two hose bands or the like, integrated and used in place thereof.

While the first folded portions having specific shapes are formed in each of the aforementioned second and third embodiments, other shapes may be employed so far as at least parts of the barrel portion 33 are folded in the perpendicular direction inward to constitute the first folded portions on the first end of the barrel portion 33 closer to the blade 20a and the barrel portion 33 is connected by the first flange portion 35 through the first folded portions.

While the second folded portions having specific shapes are formed in each of the aforementioned second and third embodiments, other shapes may be employed so far as at least parts of the barrel portion 33 are folded in the perpendicular direction outward to constitute the second folded portions on the second end of the barrel portion 33 closer to the shaft body and the barrel portion 33 is connected by the second flange portion 36 through the second folded portions.

While the barrel portion 33 includes the folded portions on both ends in each of the aforementioned second and third embodiments, the barrel portion 33 may include the folded portions only on one side.

While the bolt/nut assemblies 42 and 43 are fastened through the presser plates 88 and 89 in each of the aforementioned second and third embodiments, the same may be fastened without through the presser plates 88 and 89.

While the barrel portion 33 is constituted of the first cylinder 71, the second cylinder 72 and the third cylinder 73 in the aforementioned third embodiment, the same may be constituted of a plurality of cylinders overlapped with each other and having concentric sections.

While the structure of the barrel portion of the cylindrical body is specified in each of the aforementioned embodiments, another structure may be employed so far as the same has a function of being twisted when tensile force takes place in the axial direction.

While the filamentary bodies are completely embedded in the rubber stock as the structure of the barrel portion in each of the aforementioned embodiments, the filamentary bodies exhibit similar effects also when the same are partially embedded. The filamentary bodies may be prepared from other materials other than the nylon cords, and exhibit similar effects also when the filamentary bodies are bonded to and integrated with the inner surface or the outer surface of the rubber stock. In this case, similar effects are attained also when portions corresponding to the filamentary bodies are formed to be protrusions of the rubber stock.

While the flange portions are formed on both ends of the barrel portion as the connecting portions in each of the aforementioned embodiments, connecting portions of shapes other than flanges may be employed so far as the barrel portion can be connected to the blade and the shaft body.

While the filamentary bodies are linearly arranged in sheet development in each of the aforementioned embodiments, curvedly arranged ones may be used for the cylindrical body in response to the application. Alternatively, filamentary bodies formed by connecting linear portions and curved portions with each other may be used.

While the plurality of filamentary bodies of a specific number are arranged at constant intervals in each of the aforementioned embodiments, the number is not restricted to this, and the intervals may not necessarily be constant intervals either.

While the specific rubber material is used for the rubber stock for embedding the filamentary bodies in each of the aforementioned embodiments, another type of rubber material may be used.

While the rubber stock is used as the material for embedding the filamentary bodies in each of the aforementioned embodiments, another material can also be similarly used so far as the same has flexibility and elasticity and is capable of embedding the filamentary bodies therein.

While the material for embedding the filamentary bodies is not particularly decided in consideration of set conditions of the horizontal axis wind turbine in each of the aforementioned embodiments, a material less changing in rigidity by a temperature is preferably used when the horizontal axis wind turbine is set on various places from a cold district to a warm district. Alternatively, the material may be varied with the cold district and the warm district.

Although the present invention has been described and illustrated in detail, it is clearly understood that the same is by way of illustration and example only and is not to be taken by way of limitation, the scope of the present invention being interpreted by the terms of the appended claims.

1. A cylindrical body for a horizontal axis wind turbine arranged between a shaft body and a blade of the horizontal axis wind turbine, comprising:
a cylindrical barrel portion having flexibility;
a first connecting portion fixed to a first end of said barrel portion so that said blade is connected thereto; and
a second connecting portion fixed to a second end of said barrel portion and connected to said shaft body, wherein
said barrel portion is so formed that said first end twistedly rotates around an axial direction thereof with respect to said second end when tensile force acts in said axial direction and returns to the state before the rotation when said tensile force disappears.

2. The cylindrical body for a horizontal axis wind turbine according to claim 1, wherein
said barrel portion includes:
a cylindrically formed rubber stock, and
a plurality of filamentary bodies embedded in said rubber stock and arranged in a state inclined by a prescribed angle with respect to a direction parallel to said axial direction at prescribed intervals in a peripheral direction.

3. The cylindrical body for a horizontal axis wind turbine according to claim 1, wherein
said barrel portion consists of a plurality of cylinders overlapped with each other and having concentric sections, and
each of said cylinders includes:
a cylindrically formed rubber stock, and
a plurality of filamentary bodies embedded in said rubber stock and arranged in a state inclined by a prescribed angle with respect to a direction parallel to said axial direction at prescribed intervals in a peripheral direction.

4. The cylindrical body for a horizontal axis wind turbine according to claim 2 or 3, wherein
said filamentary bodies include nylon cords.

5. The cylindrical body for a horizontal axis wind turbine according to any of claims 1 to 3, wherein
at least a part of said barrel portion is folded in a perpendicular direction inward to constitute a first folded portion on said first end of said barrel portion, and said barrel portion is connected to said first connecting portion by a first fastening member through said first folded portion, and
at least a part of said barrel portion is folded in the perpendicular direction outward to constitute a second folded portion on said second end of said barrel portion, and said barrel portion is connected to said second connecting portion by a second fastening member through said second folded portion.

6. A method of manufacturing a cylindrical body for a horizontal axis wind turbine, having a cylindrical barrel portion arranged between a shaft body and a blade of the horizontal axis wind turbine, comprising the steps of:
forming a base sheet by embedding a plurality of filamentary bodies in a sheetlike elastic body in parallel with each other in a longitudinal direction and at identical intervals in a width direction;
taking out a rectangular sheet body having one side in the longitudinal direction along a direction inclined by a prescribed angle with respect to said width direction from said base sheet; and
forming said barrel portion by cylindrically bending said taken out sheet body so that said side forms one of opening end portions.

7. A method of manufacturing a cylindrical body for a horizontal axis wind turbine, having a cylindrical barrel portion arranged between a shaft body and a blade of the horizontal axis wind turbine, comprising the steps of:
forming a base sheet by embedding a plurality of filamentary bodies in a sheetlike elastic body in parallel with each other in a longitudinal direction and at identical intervals in a width direction;
taking out a rectangular sheet body having a longitudinal direction defined by a direction inclined by a prescribed angle with respect to said width direction from said base sheet;
forming a plurality of notches in said elastic body in parallel with each other at regular intervals along said filamentary bodies in a first range and a second range inward from respective edges of a first long side and a second long side of said taken out sheet body;
cylindrically bending said sheet body provided with said notches so that said first long side and said second long side form respective ones of opening end portions; and
forming said barrel portion by folding said first range of said cylindrically bent sheet body in a perpendicular direction inward thereby forming a first folded portion while folding said second range in the perpendicular direction outward thereby forming a second folded portion.

8. A method of manufacturing a cylindrical body for a horizontal axis wind turbine, having a cylindrical barrel portion arranged between a shaft body and a blade of the horizontal axis wind turbine, comprising the steps of:
forming a base sheet by embedding a plurality of filamentary bodies in a sheetlike elastic body in parallel with each other in a longitudinal direction and at identical intervals in a width direction;
taking out substantially identical rectangular first and second sheet bodies having longitudinal directions defined by directions inclined by the same prescribed angle with respect to said width direction from said base sheet;
forming a plurality of notches in said elastic body in parallel with each other at regular intervals along said filamentary bodies in first ranges and second ranges inward from respective edges of first long sides and second long sides of the respective ones of said taken out first and second sheet bodies;
overlapping said first and second sheet bodies provided with said notches with each other and integrally cylindrically bending the same so that said first long sides and said second long sides of the respective ones form respective ones of opening end portions; and
forming said barrel portion by folding said first ranges of the respective ones of said cylindrically bent first and second sheet bodies in a perpendicular direction inward in an overlapped state thereby forming first folded portions while folding said second ranges of the respective ones in the perpendicular direction outward in an overlapped state thereby forming second folded portions.

9. A method of manufacturing a cylindrical body for a horizontal axis wind turbine, having a cylindrical barrel portion arranged between a shaft body and a blade of the horizontal axis wind turbine, comprising the steps of:
forming a base sheet by embedding a plurality of filamentary bodies in a sheetlike elastic body in parallel with each other in a longitudinal direction and at identical intervals in a width direction;
taking out substantially identical rectangular first and second sheet bodies having longitudinal directions defined by directions inclined by the same prescribed angle with respect to said width direction from said base sheet;
taking out at least one rectangular third sheet body having a longitudinal direction defined by a direction inclined by an angle identical to said prescribed angle with respect to said width direction and being short only in a short-side direction in comparison with said first sheet body from said base sheet;
overlapping said taken out third sheet body between said taken out first and second sheet bodies to be held therebetween and forming a plurality of notches in said elastic body in parallel with each other at regular intervals along said filamentary bodies in first ranges and second ranges, inward from respective edges of first long sides and second long sides of the respective ones of said first sheet body and said second sheet body, with which said third sheet body is not in contact;
integrally cylindrically bending said overlapped first and second sheet bodies through said third sheet body so that said first long sides and said second long sides of the respective ones of said overlapped first and second sheet bodies form respective ones of opening end portions; and
forming said barrel portion by folding said first ranges of the respective ones of said cylindrically bent first and second sheet bodies in a perpendicular direction inward thereby forming first folded portions while folding said second ranges of the respective ones in the perpendicular direction outward thereby forming second folded portions.
